(19) United States
(12) Patent Application Publication
(10) Pub. No.: US 2005/0016678 A1
(43) Pub. Date: Jan. 27, 2005

(54) Method of manufacturing semiconductor device and manufacturing apparatus of semiconductor device

(76) Inventor: Tetsuya Kurosawa, Yokohama-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/665,206

(22) Filed: Sep. 22, 2003

(30) Foreign Application Priority Data
Jul. 22, 2003 (JP) P2003-277591

(51) Int. Cl. B32B 31/00; B32B 1/00

(52) U.S. Cl. 156/344; 156/247; 156/249; 156/584; 438/118; 156/264

(57) ABSTRACT

A manufacturing apparatus of a semiconductor device is provided with a pickup section for picking up a sectioned semiconductor element from a semiconductor wafer, a film sticking section for sticking an element adhesive film sectioned according to a shape of the element to the back surface of the semiconductor element, and an element adhesion section for adhering the semiconductor element to a semiconductor device forming base material. Chippings, which are caused when a thinned semiconductor wafer is diced, are suppressed so to reduce a failure incidence rate of the semiconductor device.

### CROSS-REFERENCE TO RELATED APPLICATION

This application is based upon and claims the benefit of priority from the prior Japanese Patent Application No. 2003-277591, filed on Jul. 22, 2003; the entire contents of which are incorporated herein by reference.

### BACKGROUND

1. Field of the Invention

The present invention relates to a method of manufacturing a semiconductor device and a manufacturing apparatus of a semiconductor device.

2. Description of the Related Art

A semiconductor device manufacturing process is roughly divided into a process of forming various types of element patterns on a front surface of a semiconductor wafer (semiconductor substrate) and a process of dividing the semiconductor wafer for individual semiconductor elements and sealing them each into a package. In recent years, the wafer is improved to have a larger diameter to reduce the manufacturing cost of semiconductor devices. In addition, the semiconductor wafer is produced to be thinner to allow high-density mounting of the semiconductor elements.

Referring from FIG. 18A to FIG. 18D, a dicing process of a conventional semiconductor wafer will be described. As described in, for example, Japanese Patent Laid-Open No. 08-051142 and Japanese Patent Laid-Open No. 2002-256235, a semiconductor wafer 1 having an element pattern formed on its front surface 1a is prepared (FIG. 18A). A back surface 1b of the semiconductor wafer 1 is ground to a prescribed thickness by mechanical grinding (FIG. 18B). After the mechanical grinding, etching (wet etching/gas etching), CMP or the like may be conducted. It is also known that grooves are previously formed in the front surface of the semiconductor wafer before its back surface is ground (see Japanese Patent Laid-Open Application No. 2001-35817).

Then, a die bonding film (die attach film or the like) 2 and a dicing tape 3 are sequentially stack to the back surface 1b of the semiconductor wafer 1 (FIG. 18C). The dicing tape 3 is provided in a tensioned state on a wafer ring 4. Then, the semiconductor wafer 1 is mechanically cut by a blade 5 or the like into individual semiconductor elements 6, 6. At this time, the die bonding film 2 is also cut off to fabricate the semiconductor elements 6 to which the die bonding film 2 is stack (FIG. 18D). The dicing tape 3 is partly cut from its front surface side so to keep holding the semiconductor elements 6.

Thus, the conventional process of dicing the semiconductor wafer 1 cuts the die bonding film 2 and the dicing tape 3 in part. Therefore, the blade 5 is liable to be blunt because it is clogged, resulting in production of large chippings (chips) in the back surface of the semiconductor elements 6. Thus, the semiconductor elements 6 become defective. Especially, the semiconductor elements 6 which are produced thin in order to realize high-density packaging have chippings in its back surface which are apt to reach the element region, resulting in an increase in the failure incidence rate. The semiconductor element having the chippings, which have reached the element region, is ruined its functions as the element.

The semiconductor elements 6 sectioned in the dicing process are picked up and given to a die bonding process. The semiconductor elements 6 which are through the dicing process are in a state that their back surface sections are stuck to the dicing tape 3. Accordingly, each semiconductor element 6 is held by an adsorption collet 7 as shown in, for example, FIG. 19, and several pushup pins 8 are pressed against the back surface to separate the semiconductor element 6 from the dicing tape 3. If the back surface of the semiconductor element 6 has chippings, the chippings may be expanded by a stress produced when the back surface of the semiconductor element 6 is pushed up. And, the semiconductor element 6 might be cracked.

The picked semiconductor element 6 is adhered to various types of envelops such as a lead frame and a substrate. Lately, the thinned semiconductor elements 6 are stacked to have a multiple layer so to improve a packing density. To form the multiple layer, the upper semiconductor element 6 is occasionally stacked on the lower semiconductor element 6 in such a way that the upper one protrudes from the outside shape of the lower one as shown in, for example, FIG. 20. If the back surface of the semiconductor element 6 has chippings, the chippings are expanded by a load applied during the wiring bonding, possibly resulting in cracking of the semiconductor element 6.

Japanese Patent Laid-Open Application No. 2000-104040 describes an adhesive film for preventing a crack or a warp from occurring when a die bonding adhesive is bonded by thermo compression to the back surface of the thinned semiconductor wafer. Here, the adhesive film is prevented from having a crack or a warp at the time of thermo compression bonding, but the adhesive film is cut together with the semiconductor wafer by dicing. Therefore, this publication is similar to Japanese Patent Laid-Open Application No. 08-051142 and Japanese Patent Laid-Open Application No. 2002-256235 on the points that the adhesive film degrades the sharpness of the blade, and large chippings are apt to occur in the back surface of the semiconductor element.

As described above, the conventional semiconductor wafer dicing process cuts the die bonding film, which is stack to the back surface of the semiconductor wafer, together with the semiconductor wafer. Therefore, the die bonding film causes the cutting blade to clog, resulting in degradation of its sharpness. Thus, large chippings tend to be produced in the back surface of the semiconductor element. And, the large chippings become a cause of defects in the semiconductor element. Especially, the chippings formed in the back surface of the thin semiconductor element tend to reach the element region and tend to expand in the following pickup process and packaging process. As a result, a failure incidence rate of the semiconductor element is increased.

It is an object of the invention to prevent a semiconductor element having a defect resulting from chippings produced in the back surface of a semiconductor wafer, and particularly a thinned semiconductor wafer, when they are diced. Specifically, it is an object of the invention to provide manufacturing method and a manufacturing apparatus of a semiconductor device which can reduce a failure incidence rate in processes ranging from dicing to die bonding.

### SUMMARY

A method of manufacturing a semiconductor device according to one embodiment of the invention comprises sectioning semiconductor elements from a semiconductor wafer, which has an element region formed on its front surface, while keeping the sectioned semiconductor elements in a state held by a holding member; picking up the sectioned semiconductor element from the holding member; sticking an element adhesive film, which is sectioned according to the shape of the semiconductor element, to the back surface of the picked semiconductor element; and adhering the semiconductor element to a semiconductor device forming base material by the element adhesive film.

A manufacturing apparatus of a semiconductor device according to one embodiment of the invention comprises a pickup section for picking up a sectioned semiconductor element from a semiconductor wafer which has sectioned semiconductor elements being held by a holding member; film sticking section for sticking an element adhesive film, which is sectioned according to the shape of the semiconductor element, to the back surface of the picked-up semiconductor element, and an element adhesion section for adhering the semiconductor element, to which the element adhesive film is stack, to a semiconductor device forming base material.

### BRIEF DESCRIPTION OF THE DRAWINGS

According to embodiments of the present invention, the present invention will be described with reference to the accompanying drawings, which are provided for an illustrated description of the invention only and do not limit the invention in any event.

FIG. 1 is a perspective diagram schematically showing an outline structure of the semiconductor manufacturing apparatus according to one embodiment of the invention.

FIG. 2 is a sectional diagram showing one example of the semiconductor wafer with sectioned semiconductor elements held by a holding member.

FIG. 3A, FIG. 3B and FIG. 3C are diagrams showing one example of the dicing process according to one embodiment of the invention.

FIG. 4A, FIG. 4B and FIG. 4C are diagrams showing another example of the dicing process according to one embodiment of the invention.

FIG. 5 is a diagram showing an example of the pickup process according to one embodiment of the invention.

FIG. 6A, FIG. 6B, FIG. 6C, FIG. 6D and FIG. 6E are side view diagrams showing an example of the process of cutting the element adhesive film by the semiconductor manufacturing apparatus shown in FIG. 1.

FIG. 7A, FIG. 7B, FIG. 7C, FIG. 7D and FIG. 7E are perspective diagrams showing an example of the process of cutting the element adhesive film by the semiconductor manufacturing apparatus shown in FIG. 1.

FIG. 8A, FIG. 8B, FIG. 8C and FIG. 8D are side view diagrams showing another example of the process of cutting the element adhesive film by the semiconductor manufacturing apparatus shown in FIG. 1.

FIG. 9A, FIG. 9B, FIG. 9C and FIG. 9D are perspective diagrams showing another example of the process of cutting the element adhesive film by the semiconductor manufacturing apparatus shown in FIG. 1.

FIG. 10 is a perspective diagram showing a modified example of FIG. 9.

FIG. 11 is a perspective diagram showing one example of the adhered structure of the semiconductor element by the semiconductor manufacturing apparatus shown in FIG. 1.

FIG. 12 is a perspective diagram showing another example of the adhered structure of the semiconductor element by the semiconductor manufacturing apparatus shown in FIG. 1.

FIG. 13 is a perspective diagram showing still another example of the adhered structure of the semiconductor element by the semiconductor manufacturing apparatus shown in FIG. 1.

FIG. 14 is a perspective diagram showing a modified example of FIG. 11.

FIG. 15 is a perspective diagram schematically showing an outline structure of the semiconductor manufacturing apparatus according to another embodiment of the invention.

FIG. 16 is a sectional diagram showing one structure example of the protective film separation section by the semiconductor manufacturing apparatus shown in FIG. 15.

FIG. 17 is a sectional diagram showing another structure example of the protective film separation section by the semiconductor manufacturing apparatus shown in FIG. 15.

FIG. 18A, FIG. 18B, FIG. 18C and FIG. 18D are diagrams showing an example of a conventional dicing process.

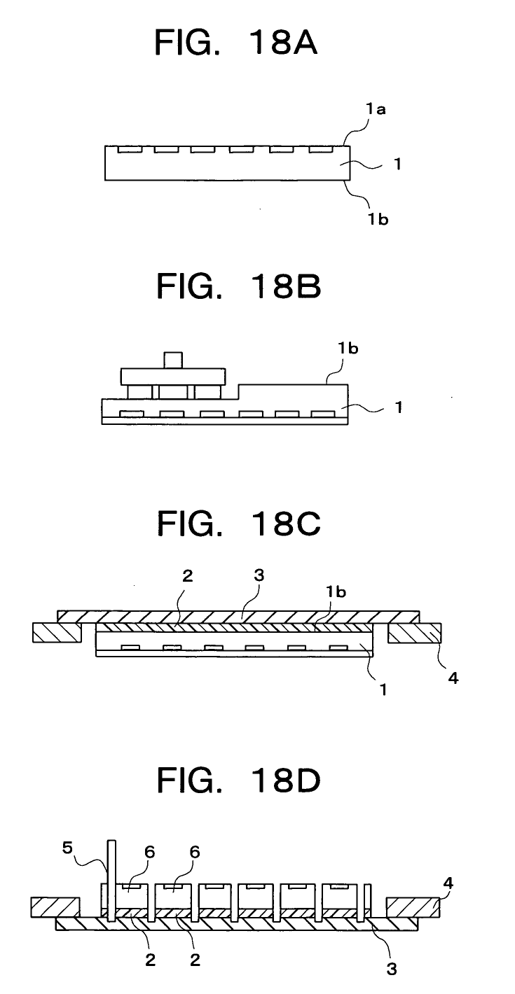

FIG. 19 is a diagram showing an example of a conventional pickup process.

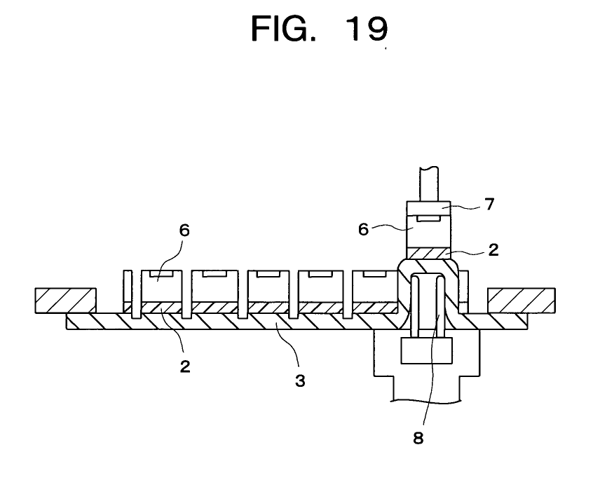

FIG. 20 is a perspective diagram showing an example of the adhered structure of a conventional semiconductor element.

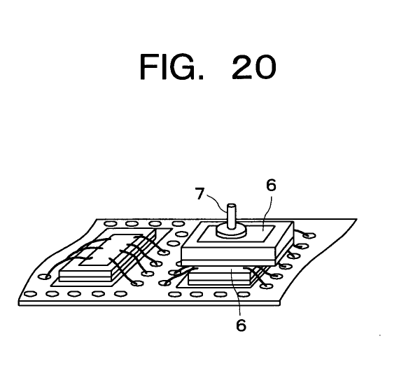

### DETAILED DESCRIPTION

(Description of Embodiments)

According to one aspect of the semiconductor device manufacturing method and the semiconductor manufacturing apparatus of the present invention, a semiconductor wafer having an element region formed on its surface is cut to form individual sectioned semiconductor elements. These sectioned semiconductor elements are held by a holding member. Then, each of the semiconductor elements is picked up from the holding member, and the element adhesive film sectioned according to the shape of the semiconductor element is stack to the back surface of the semiconductor element. Then, the element adhesive film stack to the back surface of the semiconductor element is used to adhere the semiconductor element to a semiconductor device forming base material.

According to one aspect of the invention, a holding tape such as an adhesive tape is used as the holding member. A holding table which holds the semiconductor element by vacuum attraction or the like may also be used instead of the holding tape. As the element adhesive film, a thermoplastic or thermosetting resin film such as a die attach film is used. As a semiconductor device forming base material to which the semiconductor element is adhered, various types of envelop such as a lead frame, a wiring substrate and a radiating substrate are used. For example, when the semiconductor elements are overlaid to form a multiple layer, the semiconductor element adhered to the substrate makes the semiconductor device forming base material.

According to one aspect of the invention, semiconductor elements are sectioned from a semiconductor wafer, then the element adhesive tape which is sectioned according to the element shape is stack to the back surface of each semiconductor element. Specifically, when the semiconductor wafer is subject to dicing, the element adhesive tape such as a die attach film is not cut off. Thus, chipping can be prevented from occurring in the back surface of the element in the dicing process. Therefore, a failure incidence rate of the semiconductor element in the semiconductor wafer dicing process and also a pickup process and a die bonding process after that can be lowered substantially.

The semiconductor device manufacturing method according to an embodiment of the invention has a process of sticking the holding member to the back surface of the semiconductor wafer and cutting the semiconductor wafer to form sectioned semiconductor elements while holding them by the holding member as the semiconductor element sectioning process. Another embodiment of the invention has a process of forming modified layers or grooves, which are deeper than the thickness of a completed element, from the front surface of the semiconductor wafer, a process of sticking a first holding member to the front surface of the semiconductor wafer, grinding and polishing the back surface of the semiconductor wafer and sectioning the semiconductor elements while keeping the state that they are being held by the first holding member, and a process of sticking a second holding member to the back surfaces of the semiconductor elements and separating the first holding member as the semiconductor element sectioning process.

The semiconductor device manufacturing method according to an embodiment of the invention also has a process of supplying a long element adhesive film from a supply roll around which the element adhesive film is wound and sectioning the long element adhesive film by mechanically cutting or laser cutting it depending on the shape of the semiconductor element. Another embodiment of the invention has a process of holding the sectioned element adhesive film by a porous adsorption member and sticking the element adhesive film held by the adsorption member to the back surface of the semiconductor element as the element adhesive film sticking process.

The semiconductor manufacturing apparatus according to an embodiment of the invention is provided with a film sticking section which has a film supply section for supplying the long element adhesive film from the supply roll around which the element adhesive film is wound and a film cutting section for cutting the element adhesive film supplied from the supply roll by mechanical cutting or laser cutting depending on the shape of the semiconductor element. The film cutting section has, for example, an adsorption member for holding the element adhesive film and a cutting mechanism for cutting the element adhesive film being held by the adsorption member by stamping.

According to another embodiment of the invention, the film cutting section has an adsorption member for holding the element adhesive film, a laser cutting mechanism for cutting the element adhesive film which is held by the adsorption member and a moving mechanism for moving the laser cutting mechanism or the adsorption member depending on the shape of the semiconductor element. In the above embodiments, the adsorption member is formed of, for example, a porous metal. The adsorption member may be formed of porous ceramics or the like.

The semiconductor fabrication apparatus according to another embodiment of the invention is provided with a pickup section which has an adsorption collet for holding the semiconductor element and a push-up mechanism for pushing up the back surface of the semiconductor element being held by the adsorption collet to separate it from the holding member. The adsorption collet of this embodiment is made of, for example, a porous metal. The adsorption collet may be formed of porous ceramics or the like. Besides, according to another embodiment, the semiconductor manufacturing apparatus has a film separation section for separating a protective film formed on the back surface of the element adhesive film stack to the semiconductor element.

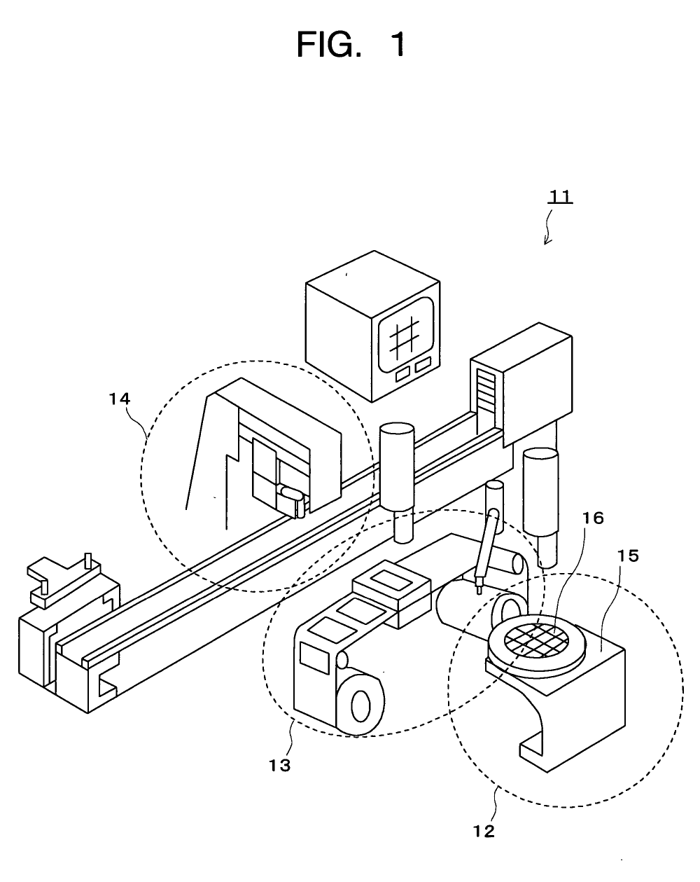

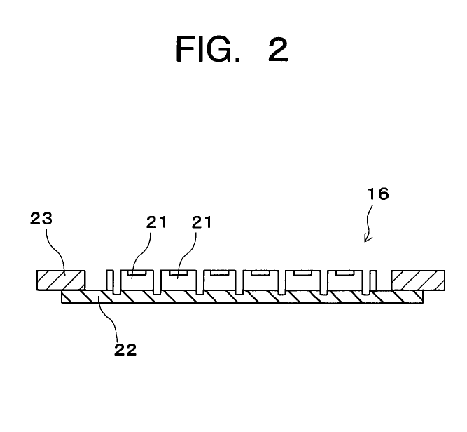

Embodiments of the semiconductor device manufacturing method and semiconductor device manufacturing apparatus of the invention will be described with reference to the drawings. FIG. 1 is a diagram showing a schematic structure of the semiconductor manufacturing apparatus according to one embodiment of the invention. A semiconductor manufacturing apparatus 11 shown in FIG. 1 has a pickup section 12, a film sticking section 13 and an element adhesion section 14. A semiconductor wafer 16 is placed on a table 15 of the pickup section 12. As shown in FIG. 2, the semiconductor wafer 16 has plural sectioned semiconductor elements 21, 21 . . . , which are held by a holding tape 22. The holding tape 22 is provided in a tensioned state on a wafer ring 23.

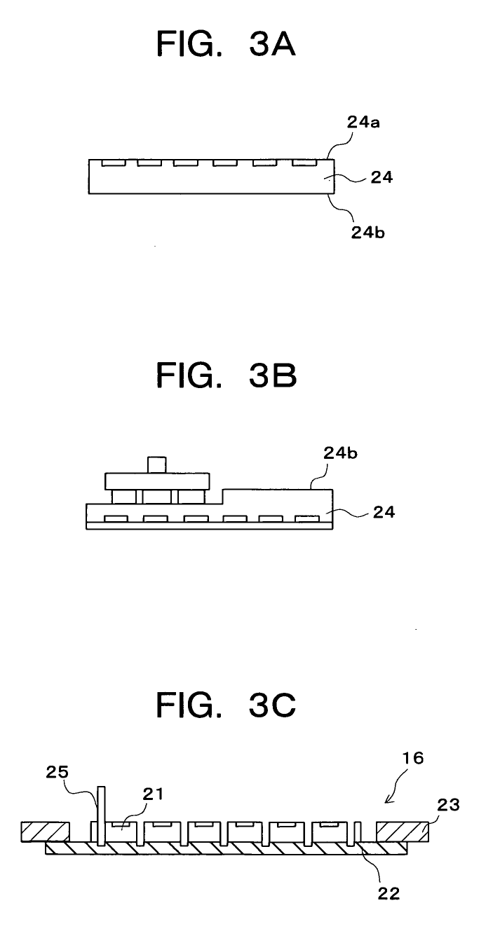

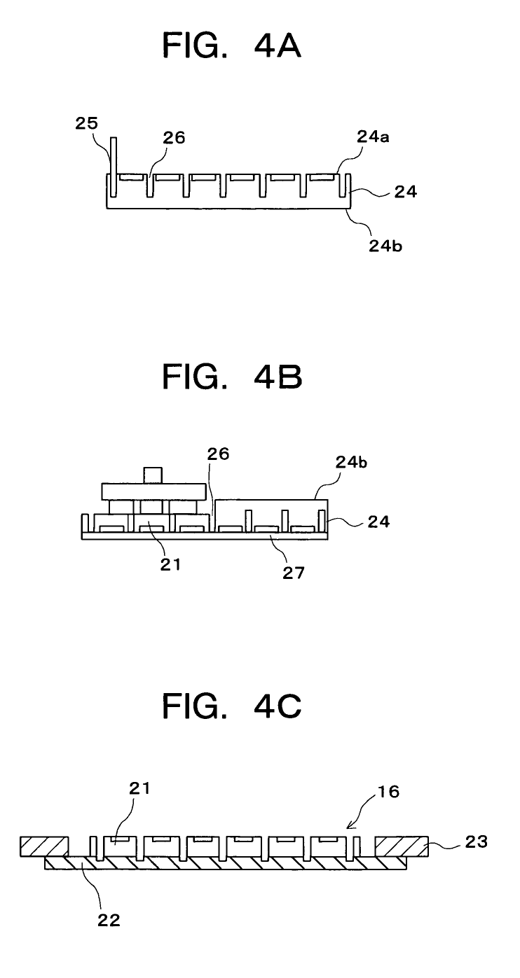

The semiconductor wafer 16 is fabricated by the dicing process shown in FIG. 3A to FIG. 3C or FIG. 4A to FIG. 4C. First, the dicing process shown in FIG. 3A to FIG. 3C will be described. As shown in FIG. 3A, a semiconductor wafer 24 having an element region formed on a front surface 24a is prepared. A back surface 24b of the semiconductor wafer 24 is ground to a prescribed thickness by mechanical grinding or the like as shown in FIG. 3B. After the mechanical grinding, wet etching, gas etching, CMP, dry polish, RIE, plasma processing may be conducted. The semiconductor wafer 24 through the grinding and polishing is determined to have a thickness depending on the thickness of the completed element.

Then, a dicing tape is stack as the holding tape 22 to the back surface 24b of the ground and polished semiconductor wafer 24. The dicing tape 22 is provided in a tensioned state on the wafer ring 23. Then, the semiconductor wafer 24 is mechanically cut by a blade 25 or the like to produce individual sectioned semiconductor elements 21 as shown in FIG. 3C. Thus, the semiconductor wafer 16 having the sectioned semiconductor elements 21 is fabricated while the semiconductor elements 21 are held by the holding tape 22.

In the above-described dicing process of the semiconductor wafer 24, the dicing tape 22 is partly cut together with the semiconductor wafer 24. But, clogging of the blade 25 is reduced substantially because the die bonding tape is not cut at the same time like a conventional dicing process. Therefore, the occurrence of chippings in the back surface of the semiconductor element 21 can be retarded substantially. In other words, the occurrence of chippings due to the degradation of sharpness can be prevented because the blade 25 is kept sharp.

Especially, the thinned semiconductor element 21, which is completed to have a thickness of 200 μm or less, and more specifically 20 μm or more and 100 μm or less, is highly influenced to have the occurrence of chippings when the sharpness of the blade 25 is degraded by clogging. For example, chippings of only about 50 μm are easy to reach the element region, and the semiconductor element 21 becomes defective. Besides, small chippings of about 10 μm become large when a load is applied in a following process, resulting in easily producing cracks. As a result, the semiconductor element 21 also becomes defective. According to the dicing process shown in FIG. 3A to FIG. 3C, the occurrence of chippings which causes a defect can be suppressed.

Then, the dicing process shown in FIG. 4A to FIG. 4C will be described. Similar to FIG. 3A, the semiconductor wafer 24 having the element region formed on the front surface 24a is prepared. As shown in FIG. 4A, grooves 26 having a prescribed depth are formed in the front surface 24a of the semiconductor wafer 24 by the blade 25 or the like. The grooves 26 are determined to have a depth which is larger than the thickness of the completed element. The grooves 26 may be formed by etching or the like. Instead of forming the grooves 26 by mechanical grinding or etching, modified layers may be formed by irradiating a laser beam to the front surface 24a of the semiconductor wafer 24. These modified layers function in the same way as the grooves 26 and have the same depth as the grooves 26 have.

As shown in FIG. 4B, a surface protective tape 27 is stack as a first holding member to the front surface 24a of the semiconductor wafer 24 where the grooves 26 are formed, and the back surface of the semiconductor wafer 24 is ground by mechanical grinding or like so to reach the grooves 26. After the mechanical grinding, wet etching, gas etching, CMP, dry polish, RIE, plasma processing may be conducted. By the grinding and polishing process to reach the grooves 26, the semiconductor elements 21 are sectioned while the semiconductor elements 21 are held by the surface protective tape 27.

Then, the holding tape 22 is stack as a second holding member to the back surface of the sectioned semiconductor elements 21 as shown in FIG. 4C, and the surface protective tape 27 is separated. A pickup tape or the like is used for the holding tape 22. Thus, the semiconductor wafer 16 which has the sectioned semiconductor elements 21 is fabricated while the semiconductor elements 21 are held by the holding tape 22. By previously dicing the semiconductor wafer 24, the occurrence of chippings in the back surface of the semiconductor element 21 can be further suppressed. Therefore, it becomes possible to obtain the semiconductor elements 21 which are substantially free from chippings.

The above-described semiconductor wafer 16 having the sectioned semiconductor elements 21 may be stack instead of the holding tape 22 a holding table for holding the semiconductor elements 21 by vacuum attraction, for example, a holding table having an adsorption section made of a porous material which is separated into adsorption areas of two blocks or more. The adsorption areas of such a holding table are mounted according to a formed row of the semiconductor elements. Each adsorption area has two vacuum exhaust systems, namely a first vacuum exhaust system for adsorption holding the semiconductor wafer 16 until the surface protective tape 27 is separated and a second vacuum exhaust system for adsorption holding the semiconductor elements 21 from which the surface protective tape 27 is separated, and these two vacuum exhaust systems are selectively used. The second vacuum exhaust system is set to enable pickup of the semiconductor element 21.

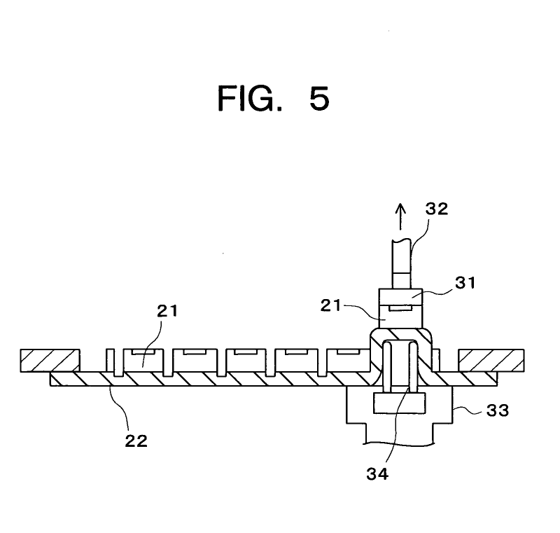

The semiconductor wafer 16 having the sectioned semiconductor elements 21 is set on the table 15 of the pickup section 12, and the sectioned semiconductor elements 21 each are picked up to separate from the holding tape 22 by the pickup section 12. As shown in FIG. 5, a moving mechanism 32 having a first adsorption collet 31 for holding and moving the semiconductor element 21 to the film sticking section 13 is disposed above the pickup table 15. A pushup mechanism 33, which pushes up the back surface of the semiconductor element 21 to separate it from the holding tape 22, is disposed beneath the pickup table 15.

The first adsorption collet 31 is made of, for example, a porous metal and can hold the semiconductor element 21 by adsorbing it by the whole surface (plane surface). By adsorption holding of the thinned semiconductor element 21 by the whole surface, a crack or a warp can be suppressed from occurring. The first adsorption collet 31 and an axis for supporting it may have a built-in heating mechanism such as a heater. Thus, adhesion between the semiconductor element 21 and an element adhesive film to be described later can be improved. The pushup mechanism 33 has several pushup pins 34 for pushing up the back surface of the semiconductor element 21.

The semiconductor element 21 is separated from the holding tape 22 by raising the semiconductor element 21 which is adsorbed and held by the above-described first adsorption collet 31 and pressing the pushup pins 34 against its back surface. The semiconductor element 21 picked up as described above is sent to the film sticking section 13 by the moving mechanism 32 having the first adsorption collet 31. When a vacuum attraction type holding table is used as the second holding member, the semiconductor element 21 can be picked up without using the pushup mechanism 33.

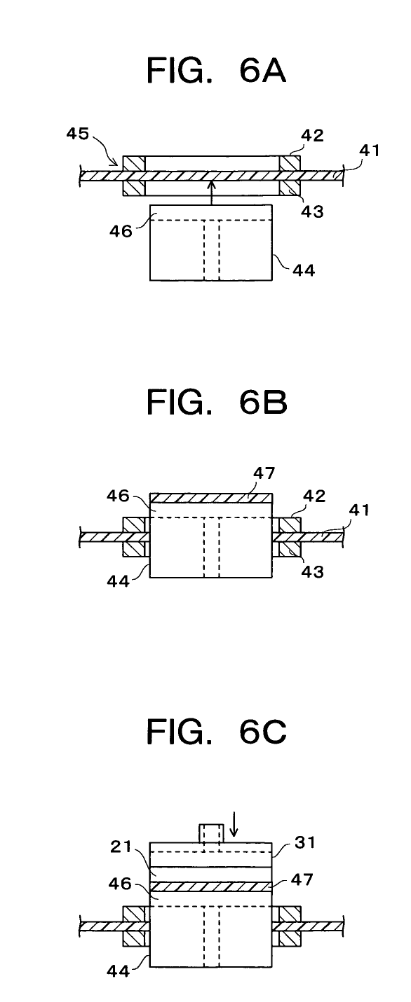

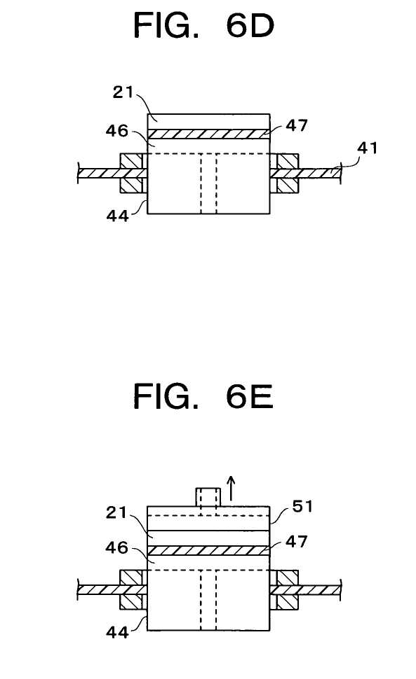

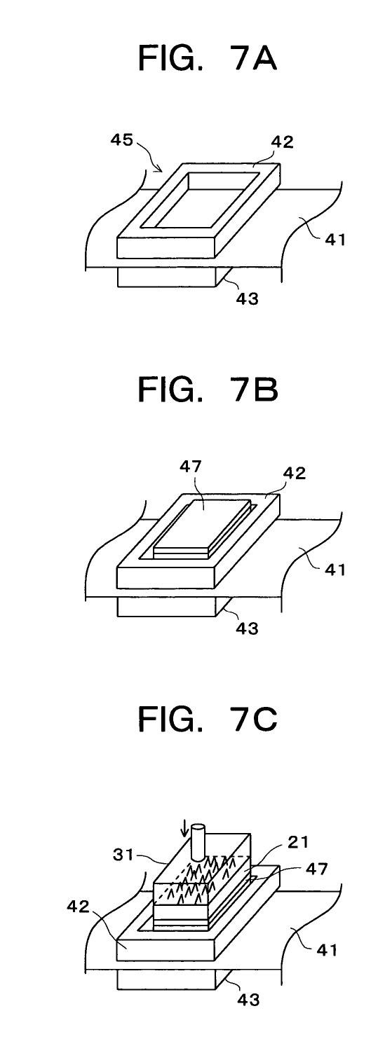

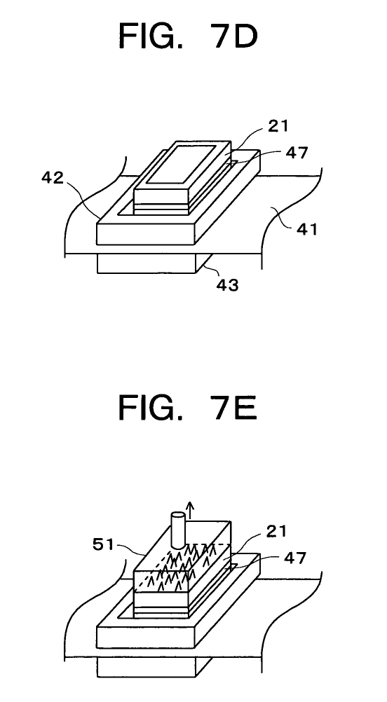

The film sticking section 13 has a film cutting mechanism which cuts the element adhesive film into sections depending on the shape of the semiconductor element 21. For the film cutting mechanism, for example, a mechanical cutting mechanism as shown in FIG. 6A to 6E and FIG. 7A to FIG. 7E or a laser type cutting mechanism as shown in FIG. 8A to FIG. 8D and FIG. 9A to FIG. 9D is used. The mechanical cutting mechanism shown in FIG. 6A to FIG. 6E and FIG. 7A to FIG. 7E has as a film supply section a supply roll (not shown) around which a long element adhesive film 41 with a prescribed width is wound into a roll. A thermoplastic or thermosetting resin film such as a die attach film is used for the element adhesive film 41.

The element adhesive film 41 which is supplied from the supply roll is sent to the film cutting position. At the film cutting position, a cutting machine 45, which has a pair of upper and lower frames 42, 43 having a through hole corresponding to the element shape, and a punch die 44, which is inserted into the through holes of the frames 42, 43 to cut the element adhesive film 41, are disposed. An adsorption member 46 for holding the element adhesive film 41 is disposed at the end of the punch die 44. The adsorption member 46 is made of, for example, a porous metal and can hold the element adhesive film 41 by the whole surface (plane surface). The punch die 44 and the adsorption member 46 may have a built-in heating mechanism such as a heater. As a member for fixing the element adhesive film 41, various shapes of frames can be used.

At the film sticking section 13 having such a mechanical film cutting mechanism, the long element adhesive film 41 sent to the film cutting position is held between the upper and lower frames 42, 43 as shown in FIG. 6A and FIG. 7A. Then, the punch die 44 is moved upward from below the frame 43 to cut the long element adhesive film 41 in accordance with the shape of the semiconductor element 21 as shown in FIG. 6B and FIG. 7B. Thus, an element adhesive film 47 which is sectioned according to the shape of the semiconductor element 21 is fabricated. At this time, the sectioned element adhesive film 47 is attracted by a vacuum by means of the adsorption member 46 to improve a punching property and to prevent it from coming out of the adsorption member 46 after punching.

Then, the position of the semiconductor element 21 held by the first adsorption collet 31 and that of the sectioned element adhesive film 47 held by the adsorption member 46 are detected by a detector as shown in FIG. 6C and FIG. 7C and corrected. Then, the semiconductor element 21 is placed on the sectioned element adhesive film 47, and they are adhered together under pressure. Thus, the semiconductor element 21 having the sectioned element adhesive film 47 stack to its back surface is fabricated as shown in FIG. 6D and FIG. 7D. The sectioned element adhesive film 47 is adhered under pressure while being heated by the heater built in the first adsorption collet 31 and the punch die 44 if necessary.

The laser type cutting mechanism shown in FIG. 8A to FIG. 8D and FIG. 9A to FIG. 9D has as a film supply section a supply roll (not shown), around which the long element adhesive film 41 having a prescribed width is wound to have a roll shape in the same way as the mechanical cutting mechanism. The element adhesive film 41 supplied from the supply roll is sent to the film cutting position. An adsorption section 48 for holding the element adhesive film 41 by vacuum attraction and a laser irradiation section 49 are disposed at the film cutting position. The laser irradiation section 49 can be moved by an unshown moving mechanism depending on the element shape. The adsorption section 48 can also be configured to be movable.

If there is a possibility that gas is produced when the laser cutting is conducted, a suction unit 50 is disposed around the adsorption section 48. A groove for guiding the laser is disposed between the adsorption section 48 and the suction unit 50. The adsorption section 48 is made of a porous metal or the like in the same way as the above-described mechanical cutting mechanism to allow holding the element adhesive film 41 by the whole surface (plane surface). And, the adsorption section 48 may have a built-in heating mechanism such as a heater.

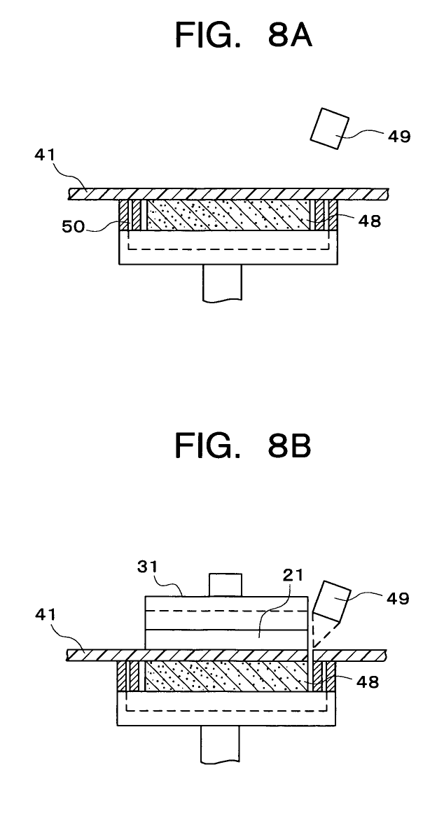

In the film sticking section 13 having a laser type film cutting mechanism, the long element adhesive film 41 sent to the film cutting position is adsorbed and held by the adsorption section 48 by vacuum as shown in FIG. 8A. As shown in FIG. 8B and FIG. 9B, the semiconductor element 21 being held by the first adsorption collet 31 is placed on the element adhesive film 41 which is held by the adsorption section 48. The long element adhesive film 41 is cut according to the shape of the semiconductor element 21 by moving the laser irradiation section 49 according to the element shape with the semiconductor element 21 being kept under vacuum attraction. The adsorption section 48 may be moved to cut the element adhesive film 41 according to the element shape as shown in FIG. 10.

Thus, the element adhesive film 41 is sectioned by cutting according to the shape of the semiconductor element 21. Then, the semiconductor element 21 and the sectioned element adhesive film 47 are mutually adhered under pressure and may be adhered by thermocompression if necessary, to fabricate the semiconductor element 21, which has the sectioned element adhesive film 47 stack to its back surface, as shown in FIG. 8C and FIG. 9C. FIG. 8D and FIG. 9D show a moved state of the semiconductor element 21. The element adhesive film 41 may be cut alone before the semiconductor element 21 is placed.

In the contact bonding (sticking) process of the element adhesive film 47 by the above-described individual cutting mechanisms, the element adhesive film 47 sectioned according to the element shape is stack to the back surface of the semiconductor element 21 which is prevented from having the occurrence of chippings. Therefore, chippings are not caused in the back surface of the semiconductor element 21 even when the element adhesive film 47 is sectioned like the conventional process by which the element adhesive film is sectioned by cutting together with the semiconductor wafer. Thus, a failure incidence rate of the semiconductor element resulting from chippings can be lowered. Especially, a failure incidence rate of the thinned semiconductor element 21 is lowered substantially.

Besides, in the above-described contact bonding (sticking) process of the element adhesive film 47, the semiconductor element 21 and the element adhesive film 47 are adsorbed by vacuum so to keep a plane state, so that a crack or a warp of the semiconductor element 21 at the time of contact bonding and an unadhered portion (hole) on the stack surface can be suppressed from occurring. The occurrence of an unadhered portion (hole) causes a reduction in heat dissipation from the semiconductor element 21. When such a cause of a defect is reduced or eliminated, a production yield of the semiconductor element 21 and also that of the semiconductor device using it can be improved.

The semiconductor element 21, to which the element adhesive film 47 is stack, is detected again for its position by the detector, corrected its position and sent to the element adhesion section 14 while being held under attraction by a second adsorption collet 51 as shown in FIG. 6E and FIG. 7E. The second adhesion collet 51 is mounted on the leading end of the moving mechanism of the element adhesion section 14, and its specific configuration is the same as that of the first adsorption collet 31. The first adsorption collet 31 only may be used to move the semiconductor element 21 from the pickup section 12 to the element adhesion section 14.

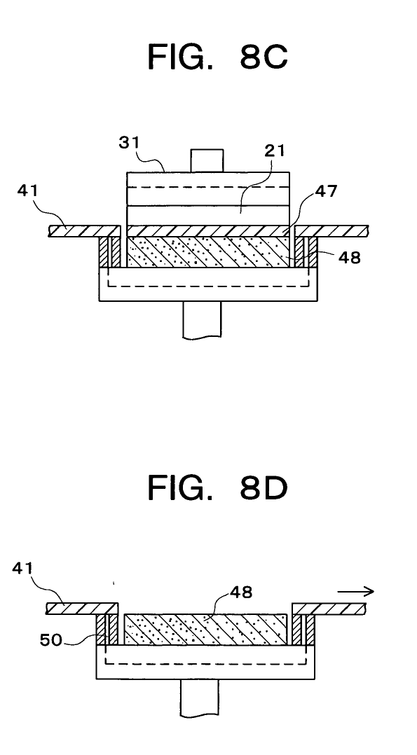

At the element adhesion section 14, the semiconductor element 21, to which the element adhesive film 47 is stack, is adhered to, for example, a lead frame, a wiring substrate, a radiating substrate or other various types of envelopes or a semiconductor element which is adhered to the substrate when it is multilayered. For example, as shown in FIG. 11, the semiconductor element 21 held by the second adsorption collet 51 is sent to a prescribed position on a wiring substrate 52 and adhered to the wiring substrate 52 by applying a load to the element adhesive film 47. The loads at the film sticking section 13 and the element adhesion section 14 are adequately controlled in the respective stages. Then the terminals of the semiconductor element 21 and the wiring substrate 52 are connected by bonding wires, and they are sent to a prescribed packaging process to fabricate a semiconductor device.

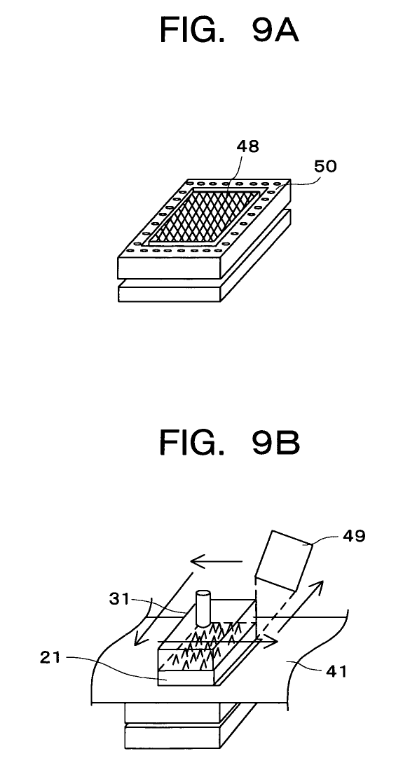

FIG. 12 shows a state that the semiconductor elements 21 are multilayered. Specifically, the first semiconductor element 21 adhered onto the wiring substrate 52 is wire-bonded, and the substrate 52 is placed again on the semiconductor fabrication apparatus 11. And, the second semiconductor element 21 is adhered to the first semiconductor element 21 by the same process. As shown in FIG. 12, where the second semiconductor element 21 is stacked on the first semiconductor element 21 to protrude from it, a bending stress is applied to the second semiconductor element 21 by wire bonding. In this case, cracks resulting from the expansion of chippings can be avoided from occurring because the semiconductor element 21 is prevented from having chippings.

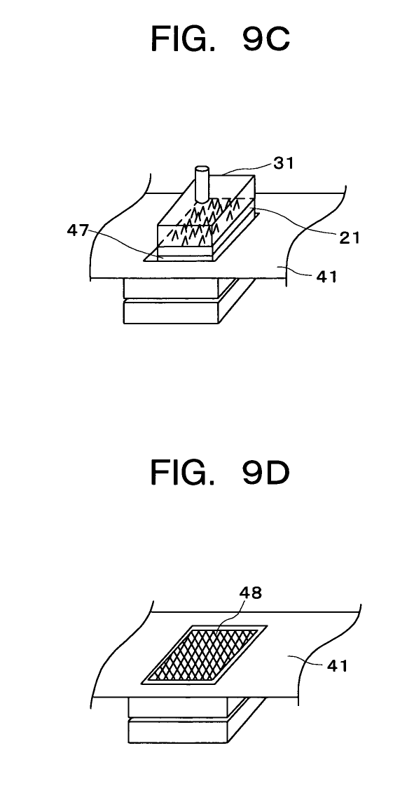

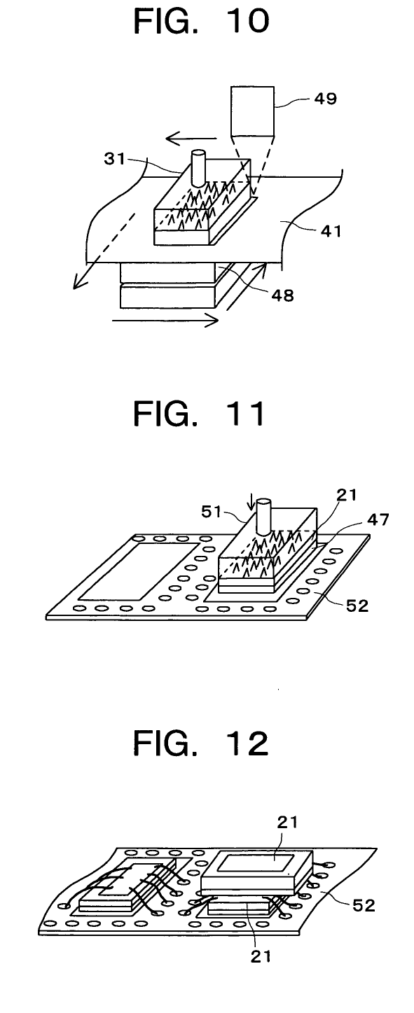

The multiple layer of the semiconductor elements 21 is not limited to the aspect shown in FIG. 12, but when the upper semiconductor element 21 is small or the upper and lower semiconductor elements 21 have the same shape and stacked in the same direction as shown in FIG. 13, various stacking forms can be applied. In any case, it is possible to prevent any defect from occurring in the semiconductor element 21. Besides, the semiconductor element 21 which has the element adhesive film 47 stack to its back surface may be temporarily moved to a tray 53 and adhered to a substrate or the like as shown in, for example, FIG. 14.

According to the above-described semiconductor device fabrication process, a failure incidence rate can be reduced substantially because chippings are prevented from occurring in the back surface of the semiconductor element 21. It is because a failure incidence rate of the semiconductor wafer 24 in the dicing process is lowered, and a crack is prevented from occurring in the subsequent pickup process or wire bonding process. Thus, a failure incidence rate of the particularly thinned semiconductor element 21 caused by chippings can be lowered substantially. Specifically, by using, for example, a semiconductor element 21 having a thickness of 200 μm or less, and more particularly 20 μm or more and 100 μm or less, a thinned semiconductor device or a semiconductor device having realized high-density packaging can be produced with a high yield.

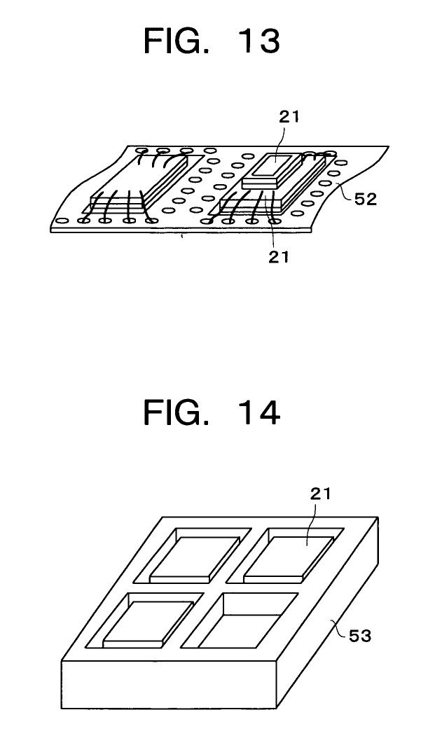

The element adhesive film includes a type which is adhered to the semiconductor element by its adhesive layer and has a protective film adhered to the whole surface of the element adhesive film. When this element adhesive film is used, the film sticking section 13 having a protective film separation section 61 is applied as shown in FIG. 15. The protective film separation section 61 has an adhesive tape 62 for separating the protective film. The semiconductor element 21, to which the element adhesive film 47 is stack, is temporarily pressed against the adhesive tape 62 to separate the protective film 63 from the back surface by the adhesive tape 62 and is sent to the element adhesion section 14.

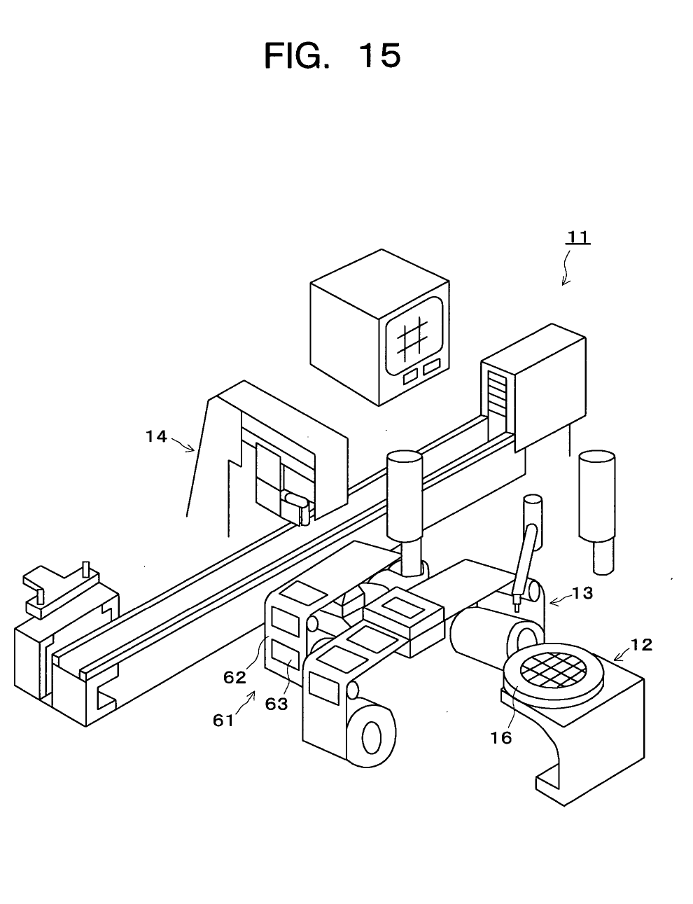

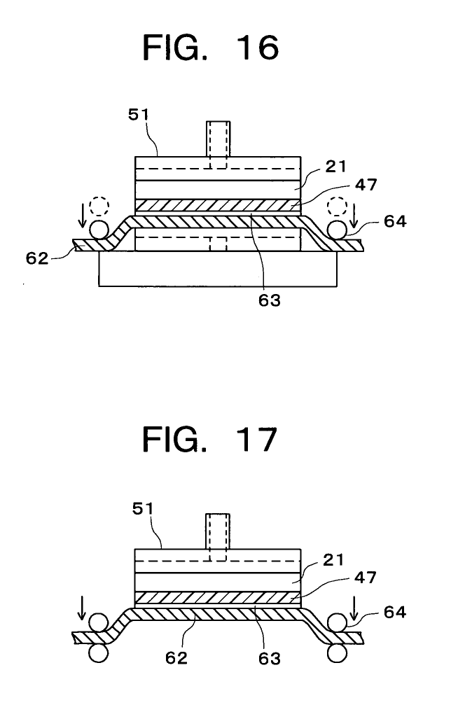

FIG. 15 shows an apparatus configuration which has the protective film separation section 61 and the film sticking section 13 disposed in a moving direction of the semiconductor element, but they may be disposed in a direction to be at right angles to the moving direction (parallel arrangement). And, the protective film separation section 61 may have a mechanism 64 which moves the adhesive tape 62 pressed against the semiconductor element 21 downward to separate the protective film 63 as shown in, for example, FIG. 16 and FIG. 17. The adhesive tape 62 may be moved by moving down the right and left separation members at the same time or moving down them sequentially (e.g., order of right and left).

It is to be understood that the present invention is not limited to any particular embodiments descried here with reference to the accompanying drawings but various changes and modifications may be made in the invention without departing from the spirit and scope of the claims attached.

1. A method of manufacturing a semiconductor device comprising:
sectioning semiconductor elements from a semiconductor wafer, which has an element region formed on its front surface, while keeping the sectioned semiconductor elements in a state held by a holding member;
picking up the sectioned semiconductor element from the holding member;
sticking an element adhesive film, which is sectioned according to the shape of the semiconductor element, to the back surface of the picked semiconductor element; and
adhering the semiconductor element to a semiconductor device forming base material by the element adhesive film.

2. The method of manufacturing a semiconductor device according to claim 1,
wherein the semiconductor element sectioning process has a process of sticking the holding member to the back surface of the semiconductor wafer and cutting the semiconductor wafer to form the sectioned semiconductor elements while keeping them in a state being held by the holding member.

3. The method of manufacturing a semiconductor device according to claim 1,
wherein the semiconductor element sectioning process has a process of forming modified layers or grooves, which are deeper than the thickness of the semiconductor element, from the front surface of the semiconductor wafer, a process of sticking a first holding member to the front surface of the semiconductor wafer, grinding and polishing the back surface of the semiconductor wafer and sectioning the semiconductor elements while keeping them in a state being held by the first holding member, and a process of sticking a second holding member to the back surfaces of the semiconductor elements and separating the first holding member.

4. The method of manufacturing a semiconductor device according to claim 1, further comprising:
supplying a long element adhesive film from a supply roll and cutting the long element adhesive film according to the shape of the semiconductor element by mechanical cutting or laser cutting to form the sectioned element adhesive film.

5. The method of manufacturing a semiconductor device according to claim 1,
wherein the element adhesive film sticking process has a process of holding the sectioned element adhesive film by a porous adsorption member and sticking the element adhesive film being held by the porous adsorption member to the back surface of the semiconductor element.

6. A manufacturing apparatus of a semiconductor device comprising:
a pickup section for picking up a sectioned semiconductor element from a semiconductor wafer which has sectioned semiconductor elements being held by a holding member;
a film sticking section for sticking an element adhesive film, which is sectioned according to the shape of the semiconductor element, to the back surface of the picked-up semiconductor element, and
an element adhesion section for adhering the semiconductor element, to which the element adhesive film is stack, to a semiconductor device forming base material.

7. The manufacturing apparatus of a semiconductor device according to claim 6,
wherein the film sticking section has a film supply section for supplying a long element adhesive film from a supply roll and a film cutting section for cutting the long element adhesive film supplied from the supply roll according to the shape of the semiconductor element by mechanical cutting or laser cutting.

8. The manufacturing apparatus of a semiconductor device according to claim 7,
wherein the film cutting section has an adsorption member for holding the element adhesive film and a cutting mechanism for cutting the element adhesive film being held by the adsorption member by stamping it.

9. The manufacturing apparatus of a semiconductor device according to claim 8,
wherein the adsorption member is made of a porous metal.

10. The manufacturing apparatus of a semiconductor device according to claim 7,
wherein the film cutting section has an adsorption member for holding the element adhesive film, a laser cutting mechanism for cutting the element adhesive film being held by the adsorption member, and a moving mechanism for moving the laser cutting mechanism or the adsorption member according to the shape of the semiconductor element.

11. The manufacturing apparatus of a semiconductor device according to claim 10,
wherein the adsorption member is made of a porous metal.

12. The manufacturing apparatus of a semiconductor device according to claim 6,
wherein the pickup section has an adsorption collet for holding the semiconductor element and a push-up mechanism for separating the semiconductor element being held by the adsorption collet from the holding member by pushing up the back surface of the semiconductor element.

13. The manufacturing apparatus of a semiconductor device according to claim 12,
wherein the adsorption collet is made of a porous metal.

14. The manufacturing apparatus of a semiconductor device according to claim 6,
wherein the film sticking section has a film separation section for separating a protective film, which is disposed on the back surface of the element adhesive film stack to the semiconductor element.
